(19) United States
(12) Patent Application Publication
(10) Pub. No.: US 2010/0243104 A1
(43) Pub. Date: Sep. 30, 2010

(54) RESIN FILLER PIPE, AND RESIN FILLER PIPE MODULES EACH EMPLOYING THE SAME

(75) Inventors: Takashi Yajima, Komaki-shi (JP); Kazutaka Katayama, Komaki-shi (JP); Kazushige Sakazaki, Komaki-shi (JP); Takahiro Shibata, Komaki-shi (JP); Hiroshi Yamada, Komaki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: TOKAI RUBBER INDUSTRIES, LTD., Komaki-shi (JP)

(21) Appl. No.: 12/749,110

(22) Filed: Mar. 29, 2010

(30) Foreign Application Priority Data
Mar. 30, 2009 (JP) 2009-082106

(51) Int. Cl. B65B 1/04; B32B 1/08

(52) U.S. Cl. 141/311 R; 428/36.91

(57) ABSTRACT

A resin filler pipe which has lower fuel permeability and excellent moldability. The resin filler pipe, which is to be provided on a fuel supply port side, is composed of an alloy material which comprises a sea phase, an island phase dispersed in the sea phase and a sea-island compatibilizing layer present between the sea phase and the island phase. The sea phase comprises a higher-acid-modification-ratio high-density polyethylene resin (A), a lower-acid-modification-ratio high-density polyethylene resin (B), and an unmodified high-density polyethylene resin (C). The island phase comprises a polyamide resin (D). The proportion of the higher-acid-modification-ratio high-density polyethylene resin (A) is 2 to 19 wt % based on the total weight of the components (A) to (D).

### BACKGROUND OF THE INVENTION

1. Field of the Invention

The present invention relates to a resin filler pipe and resin filler pipe modules each employing the resin filler pipe for use in motor vehicles.

2. Description of the Related Art

As shown in FIG. 7, a prior-art fuel supply pipe arrangement for supplying a gasoline fuel to a fuel tank in a motor vehicle and the like includes a rubber filler hose 11 extending from a fuel tank 14, and a metal filler pipe 12 connected to the filler hose 11 with its end inserted in the filler hose 11. In FIG. 7, reference characters 12a and 12b respectively denote a fuel supply port and a metal fixture with which the filler pipe 12 is fixed to a body of the motor vehicle (not shown). Further, reference characters 13 and 13a respectively denote a resin fixture pipe (joint) of the fuel tank 14 and a metal fixture of the fixture pipe 13. For the supply of the gasoline fuel into the fuel tank 14, a fuel supply gun (not shown) is inserted into the fuel supply port 12a, and the gasoline fuel is supplied into the fuel tank 14 through the filler hose 11 fixed to the fixture pipe 13 of the fuel tank 14. For global environmental preservation, preventive measures should be taken against evaporative emission of the gasoline fuel from the automotive fuel supply pipe arrangement. For this purpose, the metal filler pipe 12 described above is used as the filler pipe (see “PRIOR ART” in Japanese Patent No. 3451692).

The metal filler pipe 12 is advantageous with lower fuel (vapor) permeability, but disadvantageous in weight reduction. This leads to poor fuel economy. A conceivable approach to the weight reduction is to employ a resin filler pipe instead of the metal filler pipe 12. However, it is difficult to impart the resin filler pipe with lower fuel (vapor) permeability comparable to that of the metal filler pipe 12, and to mold the resin filler pipe with satisfactory moldability. Thus, a resin filler pipe having lower fuel permeability comparable to that of the metal filler pipe 12 and having excellent moldability is yet to be developed.

In view of the foregoing, it is an object of the present invention to provide a resin filler pipe having lower fuel permeability and excellent moldability, and a resin filler pipe module employing the resin filler pipe.

### SUMMARY OF THE INVENTION

According to a first aspect of the present invention to achieve the object described above, there is provided a resin filler pipe composed of an alloy material which comprises a sea phase, an island phase dispersed in the sea phase and a sea-island compatibilizing layer present between the sea phase and the island phase, the sea phase comprising a higher-acid-modification-ratio high-density polyethylene resin (A), a lower-acid-modification-ratio high-density polyethylene resin (B) and an unmodified high-density polyethylene resin (C), the island phase comprising a polyamide resin (D), wherein the proportion of the higher-acid-modification-ratio high-density polyethylene resin (A) is 2 to 19 wt % based on the total weight of the components (A) to (D).

The resin filler pipe is connected to a filler hose with its end inserted in the filler hose in the same manner as the filler pipe 12 of FIG. 7, or with its end welded to an end of the filler hose.

According to a second aspect of the present invention, there is provided a resin filler pipe module. The module according to the second inventive aspect is a modification of the resin filler pipe, which includes a filler pipe part and a filler hose part unitarily formed. The filler pipe part and the filler hose part are composed of an alloy material, which comprises a sea phase, an island phase dispersed in the sea phase and a sea-island compatibilizing layer present between the sea phase and the island phase, the sea phase comprising a higher-acid-modification-ratio high-density polyethylene resin (A), a lower-acid-modification-ratio high-density polyethylene resin (B) and an unmodified high-density polyethylene resin (C), the island phase comprising a polyamide resin (D), wherein the proportion of the higher-acid-modification-ratio high-density polyethylene resin (A) is 2 to 19 wt % based on the total weight of the components (A) to (D).

The resin filler pipe module according to the second inventive aspect, as indicated by A1 in FIG. 1, is attached to a weld joint 15 such as of a high-density polyethylene resin welded to a fuel tank T such as of a high-density polyethylene resin. In FIG. 1, reference characters Ta and R respectively denote an opening of the fuel tank T, and an O-ring.

According to a third aspect of the present invention, there is provided a resin filler pipe module including a filler pipe part, a filler hose part and a weld joint part unitarily formed. The filler pipe part, the filler hose part and the weld joint part of the module according to the third inventive aspect are composed of an alloy material, which comprises a sea phase, an island phase dispersed in the sea phase and a sea-island compatibilizing layer present between the sea phase and the island phase, the sea phase comprising a higher-acid-modification-ratio high-density polyethylene resin (A), a lower-acid-modification-ratio high-density polyethylene resin (B) and an unmodified high-density polyethylene resin (C), the island phase comprising a polyamide resin (D), wherein the proportion of the higher-acid-modification-ratio high-density polyethylene resin (A) is 2 to 19 wt % based on the total weight of the components (A) to (D).

The resin filler pipe module according to the third inventive aspect, as indicated by A2 in FIG. 2, is attached to a fuel tank T such as of a high-density polyethylene resin with its weld joint part 2 welded to the fuel tank T. In FIG. 2, reference characters 1a, 1b and Ta respectively denote the filler pipe part, the filler hose part, and an opening of the fuel tank T.

The inventors of the present invention conducted intensive studies on a resin material in order to provide a resin filler pipe having lower fuel permeability and excellent moldability. In the course of the studies, the inventors came up with an idea that the filler pipe per se is composed of an alloy material which includes a sea phase of a high-density polyethylene resin and an island phase of a polyamide resin dispersed in the sea phase. Based on this idea, the inventors further conducted studies on the high-density polyethylene resin for the sea phase. As a result, the inventors found that a resin filler pipe having lower fuel permeability comparable to that of the prior-art metal filler pipe and excellent moldability can be provided by employing an alloy material which contains a higher-acid-modification-ratio high-density polyethylene resin (A), a lower-acid-modification-ratio high-density polyethylene resin (B) and an unmodified high-density polyethylene resin (C) as the high-density polyethylene resin with the proportion of the higher-acid-modification-ratio high-density polyethylene resin (A) set to 2 to 19 wt % based on the total weight of the components (A) to (D) and has a sea-island compatibilizing layer formed between the sea phase and the island phase. Thus, the inventors attained the present invention.

A reason for reduction in fuel permeability is not known, but is supposedly as follows. As shown in a scanning electron micrograph (SEM) of FIG. 3, the alloy material for the inventive resin filler pipe has compatibilizing layers (white blurry layers) present in interfaces between the sea phase (a black portion) and the island phase (white portions). The inventors studied and analyzed the compatibilizing layers, and supposed that the higher-acid-modification-ratio high-density polyethylene resin (A) in the sea phase is linearly bonded to the polyamide resin (D) in the island phase and the resulting resin serves as a compatibilizing agent for stabilization of the sea-island interfaces. In the compatibilizing layers, the lower-acid-modification-ratio high-density polyethylene resin (B) in the sea phase is supposedly graft-bonded to the polyamide resin (D) in the island phase, and the resulting resin serves as a compatibilizing agent for adhesion to the polyamide resin (D). Further, the unmodified high-density polyethylene resin (C) in the sea phase serves for the tensile strength of the sea-island structure. For this reason, the compatibilizing layers supposedly enhance the compatibilization in the sea-island interfaces in the alloy material shown in FIG. 3. The alloy material shown in FIG. 3 is free from separation at the sea-island interfaces which may otherwise occur in a prior-art resin alloy material when it is expanded due to immersion in a fuel. The sea-island interfaces do not form a fuel penetration path (through which the fuel leaks), thereby lowering the fuel permeability.

As shown in a scanning electron micrograph of FIG. 4, the prior-art resin alloy material (including a sea phase containing the unmodified high-density polyethylene resin (C) alone, and an island phase containing the polyamide resin (D) and dispersed in the sea phase) has virtually no compatibilizing layer in an interface between the sea phase (a black portion) and the island phase (white portions). A comparison between the alloy material of FIG. 3 and the alloy material of FIG. 4 indicates that the prior-art alloy material shown in FIG. 4 has higher island phase dispersibility. This indicates that the formation of the compatibilizing layers in the sea-island interfaces is more important and more effective for the lowering of the fuel permeability than the island phase dispersibility.

The inventive resin filler pipe is composed of the alloy material having the sea phase containing the higher-acid-modification-ratio high-density polyethylene resin (A), the lower-acid-modification-ratio high-density polyethylene resin (B) and the unmodified high-density polyethylene resin (C), and the island phase containing the polyamide resin (D) and dispersed in the sea phase. The proportion of the higher-acid-modification-ratio high-density polyethylene resin (A) in the alloy material is 2 to 19 wt % based on the total weight of the components (A) to (D), and the alloy material includes the sea-island compatibilizing layer present between the sea phase and the island phase. Therefore, the resin filler pipe has lower fuel permeability and excellent moldability. Further, as described above, the resin filler pipe is imparted with improved tensile strength, because the higher-acid-modification-ratio high-density polyethylene resin (A) is blended.

The resin filler pipe modules according to the second and third inventive aspects, which are each provided as a unitary part, each have lower fuel permeability, and achieve cost reduction due to reduction in the number of parts. That is, where a filler pipe is combined with a filler hose and a joint (fixture pipe) for modularization, the prior art encounters the following problems. In general, the filler pipe is composed of a metal, and the filler hose is composed of a rubber. Further, the joint is composed of a resin. That is, these parts are composed of materials having different properties. Therefore, where these parts are combined with each other for the modularization, a fuel is liable to leak from junctures between these parts. Further, these parts are separately produced, so that the costs are disadvantageously increased with a greater number of parts. In the resin filler pipe module according to the second inventive aspect (first module), the filler pipe part and the filler hose part are unitarily formed of the alloy material. In the resin filler pipe module according to the third inventive aspect (second module), the filler pipe part, the filler hose part and the weld joint part are unitarily formed of the alloy material. Without the need for combining these parts as in the prior art, the problem of the leak of the fuel from the junctures can be eliminated. Since the resin filler pipe module including the weld joint part as a unitary part thereof according to the third inventive aspect is composed of the alloy material, the joint part has excellent weldability (weld strength) to an outermost layer of the resin fuel tank composed of a high-density polyethylene resin (hereinafter referred to as “HDPE”). Therefore, the joint part can be directly welded to the resin fuel tank, thereby obviating the need for providing a weld member between the joint and the fuel tank. This suppresses increase in the number of parts and increase in costs.

Where the proportion of the polyamide resin (D) in the alloy material is 25 to 37 wt % based on the total weight of the components (A) to (D), the fuel permeability is lowered.

Where the total proportion of the higher-acid-modification-ratio high-density polyethylene resin (A) and the lower-acid-modification-ratio high-density polyethylene resin (B) in the alloy material is 20 to 35 wt % based on the total weight of the components (A) to (D) and the proportion of the unmodified high-density polyethylene resin (C) in the alloy material is 30 to 50 wt % based on the total weight of the components (A) to (D), the fuel permeability is further lowered.

Where the thickness of the compatibilizing layer is 100 to 350 nm, the separation at the sea-island interfaces is suppressed, and the fuel permeability is further lowered.

### BRIEF DESCRIPTION OF THE DRAWINGS

FIG. 1 is a diagram for explaining connection between an inventive resin filler pipe module (including a filler pipe part and a filler hose part) and a weld joint welded to a resin fuel tank.

FIG. 2 is a diagram illustrating an inventive resin filler pipe module (including a filler pipe part, a filler hose part and a weld joint part) welded to a resin fuel tank.

FIG. 3 is a scanning electron micrograph (SEM) of an alloy material for an inventive resin filler pipe (taken at a magnification of ×10000).

FIG. 4 is a scanning electron micrograph (SEM) of a prior-art alloy material (taken at a magnification of ×10000).

FIG. 5 is a sectional view of a test piece formed from a pellet material (alloy material) of any of inventive examples and comparative examples.

FIG. 6 is a sectional view illustrating a test device used for measuring the fuel permeation amount of the test piece formed from the pellet material (alloy material) of any of the inventive examples and the comparative examples.

FIG. 7 is a diagram schematically showing the construction of a prior-art automotive fuel supply pipe arrangement.

### DETAILED DESCRIPTION OF PREFERRED EMBODIMENTS

The present invention will hereinafter be described by way of embodiments thereof.

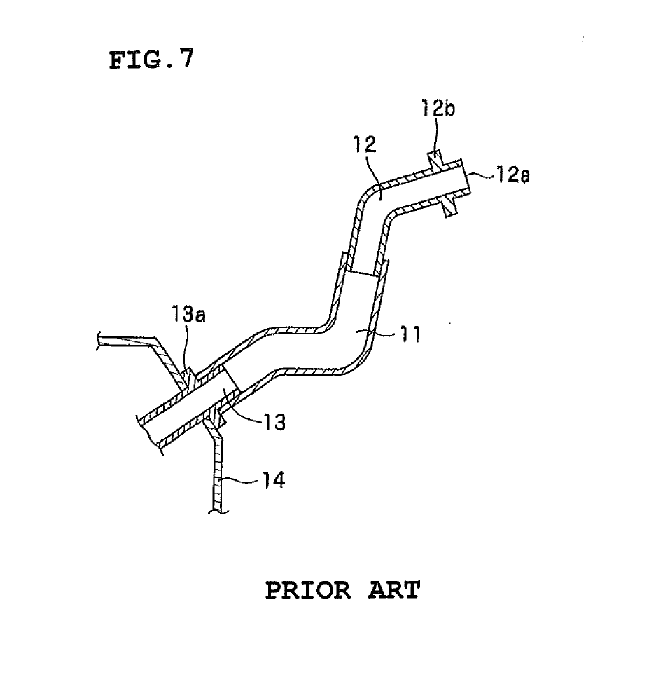

A notable feature of the inventive resin filler pipe (corresponding to the metal filler pipe 12 in FIG. 7) is that the filler pipe per se is composed of a specific alloy material to be described later. Thus, the resin filler pipe is imparted with lower fuel permeability.

The specific alloy material has a sea phase containing a higher-acid-modification-ratio HDPE (A), a lower-acid-modification-ratio HDPE (B) and an unmodified HDPE (C), an island phase containing a polyamide resin (D) and dispersed in the sea phase, and a sea-island compatibilizing layer present between the sea phase and the island phase. Here, the higher-acid-modification-ratio HDPE (A) and the lower-acid-modification-ratio HDPE (B) are HDPEs each modified with an acid such as an unsaturated carboxylic acid derivative, and the unmodified HDPE (C) is an HDPE that is not modified. The higher-acid-modification-ratio HDPE (A) is prepared by modification with a greater amount of the acid (or contains a greater amount of an acid component) than the lower-acid-modification-ratio HDPE (B).

In the alloy material, the higher-acid-modification-ratio HDPE (A) is typically present in a proportion of 2 to 19 wt %, preferably 2 to 10 wt %, particularly preferably 3 to 8 wt %, based on the total weight of the components (A) to (D). If the proportion of the higher-acid-modification-ratio HDPE (A) is too low, the island phase is not properly dispersed in the sea phase, resulting in insufficient material strength. Further, the weldability between a weld joint part of a resin filler pipe module and a fuel tank is impaired. On the other hand, if the proportion of the higher-acid-modification-ratio HDPE (A) is too high, the fuel permeability is increased.

In the alloy material, the higher-acid-modification-ratio HDPE (A) and the lower-acid-modification-ratio HDPE (B) are preferably present in a total proportion of 20 to 35 wt %, particularly preferably 27 to 30 wt %, based on the total weight of the components (A) to (D). In the alloy material, the unmodified HDPE (C) is preferably present in a proportion of 30 to 50 wt %, particularly preferably 35 to 45 wt %, based on the total weight of the components (A) to (D).

In the alloy material, the polyamide resin (D) is preferably present in a proportion of 25 to 37 wt %, particularly preferably 30 to 35 wt %, based on the total weight of the components (A) to (D). If the proportion of the polyamide resin (D) is too low, the proportions of the HDPEs (A) to (C) are relatively increased, resulting in higher fuel permeability. On the other hand, if the proportion of the polyamide resin (D) is too high, the weldability between the weld joint part of the resin filler pipe module and the fuel tank tends to be impaired.

The higher-acid-modification-ratio HDPE (A), the lower-acid-modification-ratio HDPE (B) and the unmodified HDPE (C) each have a higher density than an ordinary polyethylene (PE). The higher-acid-modification-ratio HDPE (A), the lower-acid-modification-ratio HDPE (B) and the unmodified HDPE (C) each typically have a specific gravity of 0.93 to 0.97, preferably 0.93 to 0.96, and a melting point of 120° C. to 145° C. The specific gravity is determined in conformity with ISO 1183, and the melting point is determined in conformity with ISO 3146.

The acid modification ratio of the higher-acid-modification-ratio HDPE (A) is preferably not less than 2.0 wt %, particularly preferably 2.0 to 2.5 wt %. The acid modification ratio of the lower-acid-modification-ratio HDPE (B) is preferably not less than 0.5 wt % and less than 2.0 wt %, particularly preferably 0.5 to 1.0 wt %. Examples of the acid include unsaturated carboxylic acids and unsaturated carboxylic acid derivatives, which may be used either alone or in combination.

The higher-acid-modification-ratio HDPE (A) and the lower-acid-modification-ratio HDPE (B) may be prepared, for example, by graft-modifying an HDPE with a modification compound (an unsaturated carboxylic acid or an unsaturated carboxylic acid derivative) in the presence of a radical initiator. The higher-acid-modification-ratio HDPE (A) and the lower-acid-modification-ratio HDPE (B) prepared through the modification are preferably modified HDPEs each having one of functional groups such as a maleic anhydride residue, a maleic acid group, an acrylic acid group, a methacrylic acid group, an acrylate group, a methacrylate group and a vinyl acetate group, or two or more of these functional groups.

The higher-acid-modification-ratio HDPE (A) typically has a weight average molecular weight (Mw) of about 18000, and the lower-acid-modification-ratio HDPE (B) and the unmodified HDPE (C) each typically have a weight average molecular weight (Mw) of about 250000.

Examples of the polyamide resin (D) for the island phase include a polyamide-6 (PA6), a polyamide-66 (PA66), a polyamide-99 (PA99), a polyamide-1010 (PA1010), a polyamide-610 (PA610), a polyamide-612 (PA612), a polyamide-11 (PA11), a polyamide-912 (PA912), a polyamide-12 (PA12), a copolymer of a polyamide-6 and a polyamide-66 (PA6/66), and a copolymer of a polyamide-6 and a polyamide-12 (PA6/12), which may be used either alone or in combination. Among these polyamide resins, the polyamide-6 (PA6) is preferred for material costs and a barrier property.

The alloy material is prepared by blending the higher-acid-modification-ratio HDPE (A), the lower-acid-modification-ratio HDPE (B), the unmodified HDPE (C) and the polyamide resin (D) in the predetermined proportions described above, and kneading the resulting mixture, for example, at a temperature of 220° C. to 260° C. under higher shear conditions by means of a twin screw extruder (kneader).

In addition to the components (A) to (D), as required, a nucleus increasing agent (in a proportion of about 0.3 to about 0.5 wt % based on the overall weight of the alloy material), a flame retardant, an antioxidant, a lubricant, a blocking agent and the like may be added to the alloy material.

The inventive resin filler pipe is produced, for example, by a melt extrusion method, a melt injection molding method, a blow molding method or the like by employing the alloy material prepared in the aforesaid manner (typically in a pellet form). The molding/forming temperature is typically 220° C. to 260° C.

In the alloy material for the resin filler pipe, the island phase (domains) containing the polyamide resin (D) is finely dispersed in the sea phase (matrix) containing the higher-acid-modification-ratio HDPE (A), the lower-acid-modification-ratio HDPE (B) and the unmodified HDPE (C), and the sea-island compatibilizing layer is present between the sea phase and the island phase. The island phase typically has dispersion diameters of 0.5 to 10 μm, so that the alloy material has a fine sea-island structure. The sea-island structure can be observed by means of a scanning electron microscope (SEM).

The compatibilizing layer present between the sea phase and the island phase in the alloy material preferably has a thickness of 100 to 350 nm, particularly preferably 100 to 300 nm. The thickness of the compatibilizing layer is measured by means of the scanning electron microscope (SEM). Where the alloy material does not contain the higher-acid-modification-ratio HDPE (A), the compatibilizing layer in the alloy material has a thickness of less than 70 nm. Therefore, whether the higher-acid-modification-ratio HDPE (A) is present or not can be determined by measuring the thickness of the compatibilizing layer.

Next, the inventive resin filler pipe modules will be described. Examples of the inventive resin filler pipe modules include a resin filler pipe module (first module) configured such that the filler pipe 12 and the filler hose 11 (shown in FIG. 7) are unitarily formed, and a resin filler pipe module (second module) configured such that the filler pipe 12, the filler hose 11 and a weld joint (not shown but employed instead of the fixture pipe 13 in FIG. 7) are unitarily formed.

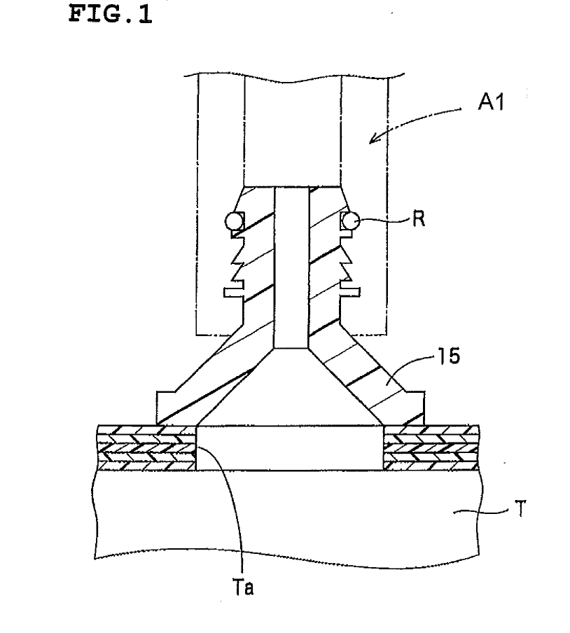

The first module includes a filler pipe part and a filler hose part unitarily formed of the alloy material. The first module is, for example, a so-called joint-fit module A1, as shown in FIG. 1, which is fitted around a resin weld joint 15 preliminarily welded to the fuel tank T. The weld joint 15 is typically formed of a HDPE, which is the same material as that for the fuel tank to be described later.

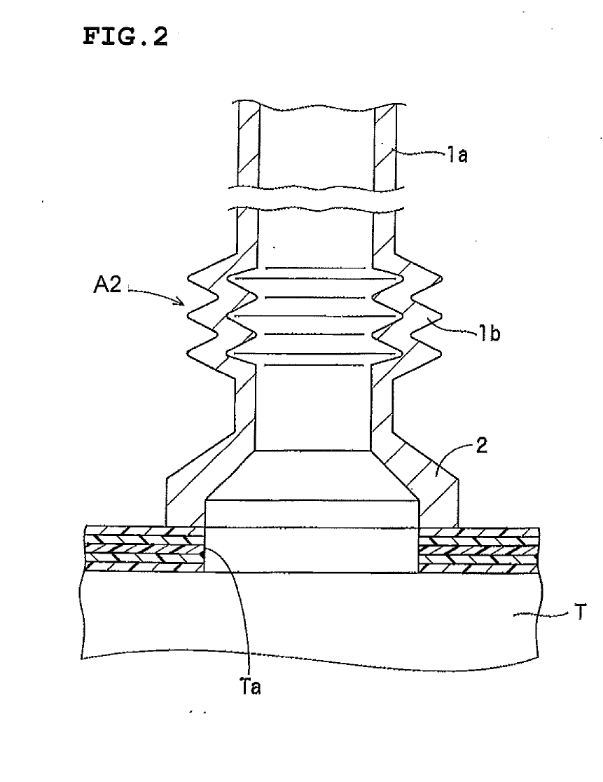

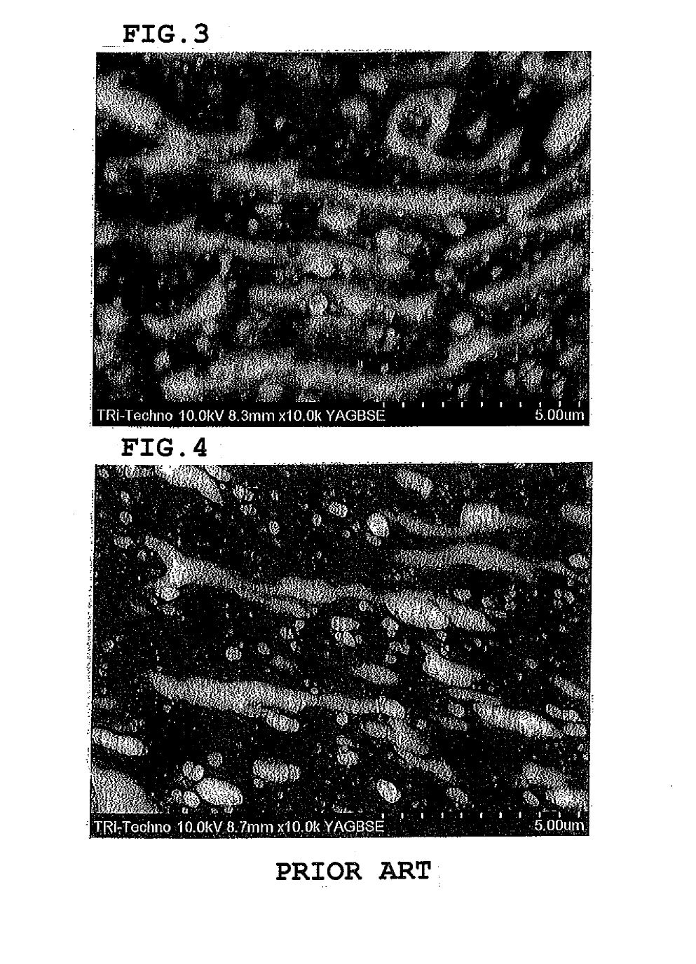

The second module is, for example, a so-called joint/filler pipe unitary module A2, as shown in FIG. 2, which includes a filler pipe part 1a, a filler hose part 1b and a weld joint part 2 unitarily formed of the alloy material. The second module A2 obviates the need for a weld member which would otherwise be required for conventional welding, because the weld joint part 2 of the module A2 is directly welded to a rim of the opening Ta of the resin fuel tank T.

The resin fuel tank T typically includes an outer surface layer (outermost layer) of a high-density polyethylene resin (HDPE). For example, the resin fuel tank T has a five-layer structure including an HDPE layer (outermost layer), a modified HDPE layer, an EVOH layer, a modified HDPE layer and an HDPE layer (innermost layer) as shown in FIG. 1.

The first module A1 is produced, for example, by a melt extrusion method, a melt injection molding method, a blow molding method or the like by employing the alloy material prepared in the aforesaid manner (typically in a pellet form). The molding/forming temperature is typically 220° C. to 260° C.

The second module A2 is produced, for example, by a melt extrusion method, a melt injection molding method, a blow molding method or the like by employing the alloy material prepared in the aforesaid manner (typically in a pellet form). The molding/forming temperature is typically 220° C. to 260° C.

The alloy material for the filler pipe part 1a, the filler hose part 1b and the weld joint part 2 preferably has a melting point of 220° C. to 260° C. (which is closer to the melting point of the outermost layer (HDPE layer) of the resin fuel tank T) for easier welding of the weld joint part 2 to the resin fuel tank T.

Exemplary methods for bonding (welding) the resin weld joint part 2 of the filler pipe module A2 to the resin fuel tank T include a heat plate welding method, a vibration welding method, an ultrasonic welding method, a laser welding method and the like, which are preferred for higher welding strength. Alternatively, the bonding of the resin weld joint part 2 may be achieved by a hot gas welding method or a rotary welding method.

The specific alloy material to be used in the present invention is also usable as a material for a purge pipe, an ORVR (Onboard Refueling Vapor Recovery) hose or other fuel supply hoses.

### EXAMPLES

Examples of the present invention will hereinafter be described in conjunction with comparative examples. It should be understood that the present invention be not limited to these inventive examples.

Prior to the description of the inventive examples and the comparative examples, ingredients of the following alloy materials will be described.

### Polyamide Resin (D)

A PA6 having an Mw of 13000 (available under the trade name of UBE NYLON 1013B from Ube Industries, Ltd.)

### Higher-Acid-Modification-Ratio HDPE (A)

An HDPE having an acid modification ratio of 2.5 wt % and an Mw of 18000 (available under the trade name of U-MEX 2000 from Sanyo Chemical Industries Ltd.)

### Lower-Acid-Modification-Ratio HDPE (B)

An HDPE having an acid modification ratio of 0.5 wt % and an Mw of about 250000 (available under the trade name of ADTEX DH0200 from Japan Polyethylene Corporation)

### Unmodified HDPE (C)

An unmodified HDPE having an Mw of 250000 (available under the trade name of HB111R from Japan Polyethylene Corporation)

With the use of the ingredients described above, the alloy materials were each prepared in a pellet form in the following manner.

### Pellet Materials I to VI (for Inventive Examples) and

### Pellet Materials VII to IX (for Comparative Examples)

Pellet alloy materials were each prepared by blending the ingredients in proportions as shown in Tables 1 and 2 and kneading the resulting mixture at a resin temperature of 270° C. by means of a twin screw kneading extruder (TEX30α available from Japan Steel Works, Ltd.) The island-in-sea dispersion state of each of the pellet materials was observed by means of a scanning electron microscope (S4800 available from Hitachi High-Technologies Corporation), and the thickness of a sea-island compatibilizing layer was measured. The results are shown in Tables 1 and 2.

TABLE 1
(wt %)

| | Pellet materials | | | | | |
|---|---|---|---|---|---|---|
| | (for inventive examples) | | | | | |
| | I | II | III | IV | V | VI |
| PA6 (D) | 30.0 | 35.0 | 35.0 | 35.0 | 35.0 | 35.0 |
| Lower-acid-modification- | 26.7 | 26.7 | 23.7 | 18.7 | 13.7 | 9.7 |
| ratio HDPE (B) | | | | | | |
| Higher-acid- | 2.0 | 2.0 | 5.0 | 10.0 | 15.0 | 19.0 |
| modification- | | | | | | |
| ratio HDPE (A) | | | | | | |
| Unmodified HDPE (C) | 41.3 | 36.3 | 36.3 | 36.3 | 36.3 | 36.3 |

Dispersion state

| Sea phase | HDPEs | | | | | |
|---|---|---|---|---|---|---|
| Island phase | PA6 | | | | | |
| Thickness of | 100 | 80 | 200 | 250 | 350 | 350 |
| compatibilizing | | | | | | |
| layer (nm) | | | | | | |
| Fuel permeability | 1.0 | 0.9 | 0.75 | 0.94 | 3.8 | 4.0 |
| (mg · mm/cm²/day) | | | | | | |

TABLE 2
(wt %)

| | Pellet materials | | |
|---|---|---|---|
| | (for comparative examples) | | |
| | VII | VIII | IX |
| PA6 (D) | 35.0 | 35.0 | 35.0 |
| Lower-acid-modification-ratio HDPE (B) | 28.7 | 27.7 | 8.7 |
| Higher-acid-modification-ratio HDPE (A) | — | 1.0 | 20.0 |
| Unmodified HDPE (C) | 36.3 | 36.3 | 36.3 |

Dispersion state

| Sea phase | HDPEs | | |
|---|---|---|---|
| Island phase | PA6 | | |
| Thickness of compatibilizing layer (nm) | 50 | 70 | 350 |
| Fuel permeability (mg · mm/cm²/day) | 1.2 | 1.2 | 8.0 |

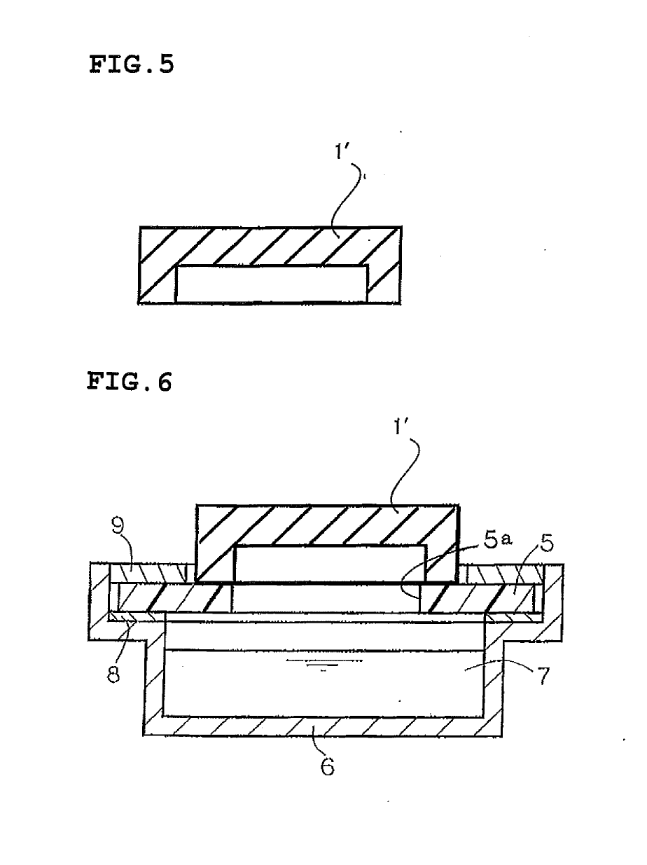

A closed-top hollow-cylindrical test piece 1′ having a height of 10 mm, an inner diameter of 70 mm, and a top and peripheral wall thickness of 4 mm as shown in FIG. 5 was prepared by melt-injecting each of the pellet materials in a mold at a molding temperature of 260° C.

The test piece thus prepared was evaluated for fuel permeability based on the following criteria. The results are shown in Tables 1 and 2.

### Fuel Permeation Amount

A sheet material (having a thickness of 10 mm) having a five layer structure of HDPE/modified HDPE/EVOH/modified HDPE/HDPE was prepared as corresponding to a component of a resin fuel tank. Then, an opening having the same diameter as the inner diameter of a lower end opening of the test piece was formed in the sheet material. With the lower end opening of the test piece being positioned with respect to the opening of the sheet material, the test piece was welded to one surface of the sheet material (a surface of the HDPE outermost layer) at 260° C. for 20 seconds by a heat plate welding method, whereby a sample was produced. Then, as shown in FIG. 6, a cup-like container 6 was prepared, and a fuel mixture (FC/E10) 7 prepared by mixing Fuel C (containing toluene and isooctane in a volume ratio of 50:50) and ethanol in a volume ratio of 90:10 was put in the container 6. In FIG. 6, reference characters 1′, 5 and 5a respectively denote the test piece, the sheet material and the opening of the sheet material. The container 6 had a stepped upper open end portion having a greater diameter, and the upper open end portion had a female thread (not shown) provided in an inner peripheral surface thereof. Then, the sample described above was fitted in the stepped portion of the container 6 via a seal rubber ring 8, and a ring-shaped threaded lid 9 was threadingly engaged with the upper open end portion to tightly press the sheet material 5 of the sample to seal the container 6. Thus, a test device was produced for measurement of a fuel permeation amount. The test device was vertically inverted and, in this state, the weight of the test device was measured in an atmosphere maintained at 40° C. once a day for one month. Then, daily weight changes were calculated, and a daily weight change observed when being stabilized was employed as a fuel permeation amount. In the present invention, the fuel permeation amount (mg·mm/cm²/day) was required to be not greater than 4.0.

As apparent from the results shown in Tables 1 and 2, the pellet materials I to VI for the inventive examples each had a smaller fuel permeation amount. Particularly, the pellet materials I to IV, which each contained the higher-acid-modification-ratio HDPE in a proportion of 2 to 10%, had lower fuel permeability. On the other hand, the pellet material IX for the comparative examples, which contained the higher-acid-modification-ratio HDPE in an excessively great amount, had higher fuel permeability with poorer island dispersibility. The pellet materials VII and VIII for the comparative examples each had a smaller fuel permeation amount, but led to poorer weldability to a filler hose and a tank and poorer fittability to a weld joint, as will be described below.

Next, resin filler pipes were produced by employing the aforementioned pellet materials.

### Examples 1 to 6 and Comparative Examples 1 to 3

Resin filler pipes each having an inner diameter of 25 mm, a thickness of 2 mm and a length of 0.5 m were produced by blow-molding the pellet materials at a molding temperature of 260° C. by means of a blow molding machine.

The resin filler pipes of Examples 1 to 6 and Comparative Examples 1 to 3 thus produced were each evaluated for weldability to a filler hose based on the following criteria. The results are shown in Tables 3 and 4.

### Weldability to Filler Hose

A resin filler hose having an inner diameter of 25 mm, a thickness of 2 mm and a length of 0.25 m was produced by blow-molding the pellet material III shown in Table 1 at a molding temperature of 260° C. by means of a blow molding machine. In turn, the resin filler pipes previously produced were each fitted around a mandrel, and the resin filler hose thus produced was fitted around the resin filler pipe. Then, the resin filler hose was welded to the resin filler pipe at a weld portion at a welding temperature of 260° C. for 20 seconds. For the weldability evaluation, a test piece was prepared by cutting a part of the weld portion, and subjected to a tensile test. A test piece broken at a portion other than the weld portion due to necking was rated as acceptable (◯), and a test piece broken due to separation at a welding interface was rated as unacceptable (x).

TABLE 3

Example

| | 1 | 2 | 3 | 4 | 5 | 6 |
|---|---|---|---|---|---|---|
| Pellet material | I | II | III | IV | V | VI |
| Weldability to filler hose | ◯ | ◯ | ◯ | ◯ | ◯ | ◯ |

TABLE 4

| | Comparative Example | | |
|---|---|---|---|
| | 1 | 2 | 3 |
| Pellet material | VII | VIII | IX* |
| Weldability to filler hose | X | X | ◯ |

*The fuel permeability was higher.

As apparent from the results shown in Tables 3 and 4, the resin filler pipes of Examples 1 to 6 were more excellent in weldability to the filler hose than the resin filler pipes of Comparative Examples 1 to 3.

Next, fit modules (first modules A1) each including a filler pipe part and a filler hose part unitarily formed were produced by employing the aforementioned pellet materials.

### Examples 7 to 12 and Comparative Examples 4 to 6

Modules each including a filler pipe part and a filler hose part unitarily formed and having an inner diameter of 25 mm, a thickness of 2 mm and a length of 0.5 m were produced by blow-molding the pellet materials at a molding temperature of 260° C. by means of a blow molding machine.

The modules of Examples 7 to 12 and Comparative Examples 4 to 6 thus produced were evaluated for fittability to a weld joint (see FIG. 1) based on the following criteria. The results are shown in Tables 5 and 6.

### Fittability to Weld Joint

The modules were each fitted around a weld joint welded to a resin fuel tank (having a five-layer structure of HDPE/modified HDPE/EVOH/modified HDPE/HDPE), and evaluated for fittability to the weld joint. For the fittability evaluation, a fuel mixture (Fuel C/M15) prepared by mixing Fuel C (containing toluene and isooctane in a volume ratio of 50:50) and methanol in a volume ratio of 85:15 was filled in the module and the resin fuel tank, and an end of the module was tightly closed. After the resulting arrangement was maintained at 80° C. for 125 hours, the module was pulled off from the weld joint. A module having a pull-off strength of not less than 98N was rated as acceptable (◯), and a module having a pull-off strength of less than 98 N was rated as unacceptable (x).

TABLE 5

Example

| | 7 | 8 | 9 | 10 | 11 | 12 |
|---|---|---|---|---|---|---|
| Pellet material | I | II | III | IV | V | VI |
| Fittability to weld joint | ◯ | ◯ | ◯ | ◯ | ◯ | ◯ |

TABLE 6

| | Comparative Example | | |
|---|---|---|---|
| | 4 | 5 | 6 |
| Pellet material | VII | VIII | IX* |
| Fittability to weld joint | X | X | ◯ |

*The fuel permeability was higher.

As apparent from the results shown in Tables 5 and 6, the modules of Examples 7 to 12 were more excellent in fittability to the weld joint than the modules of Comparative Examples 4 to 6.

Further, joint/filler pipe unitary modules (second modules A2) each including a filler pipe part, a filler hose part and a weld joint part unitarily formed were produced by employing the aforementioned pellet materials.

### Examples 13 to 18 and Comparative Examples 7 to 9

Modules each including a filler pipe part, a filler hose part (having an inner diameter of 25 mm, a thickness of 2 mm and a length of 0.6 m) and a weld joint part unitarily formed were produced by blow-molding the pellet materials at a molding temperature of 260° C. by means of a blow molding machine.

The modules of Examples 13 to 18 and Comparative Examples 7 to 9 thus produced were evaluated for weldability to a tank based on the following criteria. The results are shown in Tables 7 and 8.

### Weldability to Tank

The modules were each welded to a resin fuel tank (having a five layer structure of HDPE/modified HDPE/EVOH/modified HDPE/HDPE) at a welding temperature of 260° C. for 20 seconds. Thereafter, the modules were each evaluated for weldability to the tank. For the weldability evaluation, a test piece was prepared by cutting a part of a weld portion, and subjected to a tensile test. A test piece broken at a portion other than the weld portion due to necking was rated as acceptable (◯), and a test piece broken due to separation at a welding interface was rated as unacceptable (x).

TABLE 7

Example

| | 13 | 14 | 15 | 16 | 17 | 18 |
|---|---|---|---|---|---|---|
| Pellet material | I | II | III | IV | V | VI |
| Weldability to tank | ◯ | ◯ | ◯ | ◯ | ◯ | ◯ |

TABLE 8

| | Comparative Example | | |
|---|---|---|---|
| | 7 | 8 | 9 |
| Pellet material | VII | VIII | IX* |
| Weldability to tank | X | X | ◯ |

*The fuel permeability was higher.

As apparent from the results shown in Tables 7 and 8, the modules of Examples 13 to 18 were more excellent in weldability to the tank than the modules of Comparative Examples 7 to 9.

The resin filler pipe and the resin filler pipe modules each employing the resin filler pipe according to the present invention are used for supplying a gasoline fuel to a fuel tank in a motor vehicle and the like.

Although a specific form of embodiment of the instant invention has been described above and illustrated in the accompanying drawings in order to be more clearly understood, the above description is made by way of example and not as a limitation to the scope of the instant invention. It is contemplated that various modifications apparent to one of ordinary skill in the art could be made without departing from the scope of the invention.

What is claimed is:

1. A resin filler pipe composed of an alloy material which comprises:
a sea phase;
an island phase dispersed in the sea phase; and
a sea-island compatibilizing layer present between the sea phase and the island phase;
the sea phase comprising a higher-acid-modification-ratio high-density polyethylene resin (A), a lower-acid-modification-ratio high-density polyethylene resin (B) and an unmodified high-density polyethylene resin (C);
the island phase comprising a polyamide resin (D);
wherein the higher-acid-modification-ratio high-density polyethylene resin (A) is present in a proportion of 2 to 19 wt % based on a total weight of the components (A) to (D).

2. A resin filler pipe as set forth in claim 1, wherein the polyamide resin (D) is present in a proportion of 25 to 37 wt % based on the total weight of the components (A) to (D).

3. A resin filler pipe as set forth in claim 1,
wherein the higher-acid-modification-ratio high-density polyethylene resin (A) and the lower-acid-modification-ratio high-density polyethylene resin (B) are present in a total proportion of 20 to 35 wt % based on the total weight of the components (A) to (D),
wherein the unmodified high-density polyethylene resin (C) is present in a proportion of 30 to 50 wt % based on the total weight of the components (A) to (D).

4. A resin filler pipe as set forth in claim 1,
wherein the higher-acid-modification-ratio high-density polyethylene resin (A) has an acid modification ratio of not less than 2.0 wt %,
wherein the lower-acid-modification-ratio high-density polyethylene resin (B) has an acid modification ratio of not less than 0.5 wt % and less than 2.0 wt %.

5. A resin filler pipe as set forth in claim 1, wherein the compatibilizing layer has a thickness of 100 to 350 nm.

6. A resin filler pipe module comprising:
a filler pipe part to be provided on a fuel supply port side; and
a filler hose part extending from the filler pipe part to be provided on a fuel tank side;
the filler pipe part and the filler hose part being unitarily formed of an alloy material, which comprises:
a sea phase;
an island phase dispersed in the sea phase; and
a sea-island compatibilizing layer present between the sea phase and the island phase;
the sea phase comprising a higher-acid-modification-ratio high-density polyethylene resin (A), a lower-acid-modification-ratio high-density polyethylene resin (B) and an unmodified high-density polyethylene resin (C);
the island phase comprising a polyamide resin (D);
wherein the higher-acid-modification-ratio high-density polyethylene resin (A) is present in a proportion of 2 to 19 wt % based on a total weight of the components (A) to (D).

7. A resin filler pipe module as set forth in claim 6, wherein the polyamide resin (D) is present in a proportion of 25 to 37 wt % based on the total weight of the components (A) to (D).

8. A resin filler pipe module as set forth in claim 6, wherein the higher-acid-modification-ratio high-density polyethylene resin (A) and the lower-acid-modification-ratio high-density polyethylene resin (B) are present in a total proportion of 20 to 35 wt % based on the total weight of the components (A) to (D),
wherein the unmodified high-density polyethylene resin (C) is present in a proportion of 30 to 50 wt % based on the total weight of the components (A) to (D).

9. A resin filler pipe module as set forth in claim 6, wherein the higher-acid-modification-ratio high-density polyethylene resin (A) has an acid modification ratio of not less than 2.0 wt %,
wherein the lower-acid-modification-ratio high-density polyethylene resin (B) has an acid modification ratio of not less than 0.5 wt % and less than 2.0 wt %.

10. A resin filler pipe module as set forth in claim 6, wherein the compatibilizing layer has a thickness of 100 to 350 nm.

11. A resin filler pipe module comprising:
a filler pipe part to be provided on a fuel supply port side;
a filler hose part extending from the filler pipe part to be provided on a fuel tank side; and
a weld joint part serving as a weld portion to be welded to a fuel tank;
the filler pipe part, the filler hose part and the weld joint part being unitarily formed of an alloy material, which comprises:
a sea phase;
an island phase dispersed in the sea phase; and
a sea-island compatibilizing layer present between the sea phase and the island phase;
the sea phase comprising a higher-acid-modification-ratio high-density polyethylene resin (A), a lower-acid-modification-ratio high-density polyethylene resin (B) and an unmodified high-density polyethylene resin (C);
the island phase comprising a polyamide resin (D);
wherein the higher-acid-modification-ratio high-density polyethylene resin (A) is present in a proportion of 2 to 19 wt % based on a total weight of the components (A) to (D).

12. A resin filler pipe module as set forth in claim 11, wherein the polyamide resin (D) is present in a proportion of 25 to 37 wt % based on the total weight of the components (A) to (D).

13. A resin filler pipe module as set forth in claim 11,
wherein the higher-acid-modification-ratio high-density polyethylene resin (A) and the lower-acid-modification-ratio high-density polyethylene resin (B) are present in a total proportion of 20 to 35 wt % based on the total weight of the components (A) to (D),
wherein the unmodified high-density polyethylene resin (C) is present in a proportion of 30 to 50 wt % based on the total weight of the components (A) to (D).

14. A resin filler pipe module as set forth in claim 11,
wherein the higher-acid-modification-ratio high-density polyethylene resin (A) has an acid modification ratio of not less than 2.0 wt %,
wherein the lower-acid-modification-ratio high-density polyethylene resin (B) has an acid modification ratio of not less than 0.5 wt % and less than 2.0 wt %.

15. A resin filler pipe module as set forth in claim 11, wherein the compatibilizing layer has a thickness of 100 to 350 nm.
